(19) United States
(12) Patent Application Publication
(10) Pub. No.: US 2020/0278244 A1
(43) Pub. Date: Sep. 3, 2020

(54) Waterline Test Kit Apparatus and Related Methods

(71) Applicants: Stephen Howping Shih, San Diego, CA (US); Stephanie Tze-Fan Shih, San Diego, CA (US); William Howhong Shih, San Diego, CA (US); Geoffrey Howting Shih, San Diego, CA (US); Jeng-Kang Richard Shih, San Diego, CA (US)

(72) Inventors: Stephen Howping Shih, San Diego, CA (US); Stephanie Tze-Fan Shih, San Diego, CA (US); William Howhong Shih, San Diego, CA (US); Geoffrey Howting Shih, San Diego, CA (US); Jeng-Kang Richard Shih, San Diego, CA (US)

(21) Appl. No.: 16/290,937

(22) Filed: Mar. 3, 2019

(51) Int. Cl. G01J 1/42; C02F 1/32

(52) U.S. Cl. CPC G01J 1/429; C02F 2209/00; C02F 1/325; C02F 1/32

(57) ABSTRACT

The invention relates to a testing kit to test dental unit waterlines to meet the CDC water safety monitoring guideline using EPA compliant standards.

The CDC recommends water used in non-surgical procedures to be delivered from dental unit waterlines that follow the Environmental Protection Agency's (EPA) standard for safe drinking, which contain less than or equal to 500 colony forming units of heterotrophic bacteria per milliliter of water (≤500 CFU/mL).

The goal of the invention is the development of a cost effective in-office test kit to monitor the safety of dental unit waterlines by following suggested EPA protocol of counting bacteria colonies after bacteria has gone through an incubation period.

### BACKGROUND OF THE INVENTION

This current invention relates to a Water Test Kit device.

The invention relates to a testing kit to test dental unit waterlines to meet the CDC water safety monitoring guideline using EPA compliant standards.

The CDC recommends water used in non-surgical procedures delivered from dental unit waterlines follow the Environmental Protection Agency's (EPA) standard (see reference 2,3,4) for safe drinking to contain less than or equal to 500 colony forming units of heterotrophic bacteria per milliliter of water (≤500 CFU/mL).

The goal of the invention is the development of a simple in-office test kit to monitor the safety of dental unit waterlines by following suggested EPA protocol of counting bacteria colonies after bacteria has gone through an incubation period (see reference 6).

Currently there are some chairside in-office kits (see reference 8) available in present market: the HPC Sampler (EMD Millipore) and 3M Petrifilm. HPC Sampler consisting of a removable dip paddle (11) contained in a plastic sampler while 3M Petrifilm needed to use Pipet to draw 1 mL water from source. Both HPC Sampler and 3M Petridish plate use 1 mL tested water for colony counting.

The dip paddle of HPC Sampler contains a 0.45μ filter and an absorbent pad (12) with dehydrated agar medium (14) which absorbs 1 mL of the liquid sample, facilitating the recovery of stressed (that is, partially sanitized or nutritionally starved) aerobic bacteria in 7 days under room temperature 68-75° F. According to this manufacturer, this HPC membrane method can produce accurate readings up to 300 CFU/mL; all counts >300 CFU/mL are considered too numerous to count (TNTC). There is evidence from previous studies to show that, although the HPC Sampler underestimates bacterial counts compared with other methods, it is useful as a screening tool for regular DUWL (Dental Unit Water Line) quality monitoring in dental offices to ensure the water used in the treatment of patients meets the CDC/EPA recommendation of <500 CFU/mL.

The current invention presents a method of adapting 9215C R2A spread plate procedure in a controlled environment to process, grow and count cultured bacteria colony with or without sample dilution. Even without dilution, this method will provide valuable information for drinking water safety, such as the Dental Unit Waterline (DUWL) to meet CDC recommended monitoring standard. The result of the colony growth then can be documented.

Software such as an open coded software OpenCFU (see reference 5) or a low cost “NICE” (NIST's Integrated Colony Enumerator) can be utilized to count the colony after photos taken and eliminates the guess work in counting.

As a result, the current invention simplified the 9215s' methods (see reference 7) for an office setting and can be adapted to use where already equipped with autoclave and met State infection control protocol, eg. Dental office. Current invention make it possible to test waterline in dental office or similar setting using the kit provided.

USE OF R2A AGAR: R2A agar (Reasoner's 2A agar) was developed for culturing heterotrophic bacteria that inhabit treated drinking water. R2A is a low nutrient medium that in combination with a lower incubation temperature and longer incubation time will stimulate the growth of stressed and chlorine-tolerant bacteria. In contrast to rich media, such as Plate Count Agar, support the growth of fast-growing bacteria, but may suppress the slow growing or stressed bacteria found in treated water. Such as Enterococcus faecalis, Escherichia coli, Pseudomonas aeruginosa and Staphylococcus aureus can all grow well on R2A media.

As such, R2A Agar is recommended in standard methods for pour plate, spread plate and membrane filter methods for heterotrophic plate counts.

R2A Media components is as followed: Casein hydrolysate and peptone provide nitrogen, vitamins, amino acids, carbon and minerals. Yeast extract provides a source of trace elements and vitamins. Dextrose (Glucose) serves as a carbon source. Soluble starch aids in the recovery of injured organisms by absorbing toxic metabolic by-products. Sodium Pyruvate increases the recovery of stressed cells. Potassium phosphate is used to balance the pH and provide a source of phosphate. Magnesium sulfate is a source of Divalent Cations and Sulfate. Agar is the solidifying agent.

Media Recipe: R2A Agar Plates (per Liter), 0.05% Yeast Extract (0.5 g/L), 0.05% Proteose Peptone #3 (0.5 g/L), 0.05% Casamino Acids (0.5 g/L), 0.05% Dextrose (0.5 g/L), 0.05% Soluble Starch (0.5 g/L), 0.03% Sodium Pyruvate (0.3 g/L), 0.03% Dipotassium Phosphate (0.3 g/L), 0.005% Magnesium Sulfate (0.05 g/L), 1.5% Agar (15.0 g/L), Final pH: 7.2±0.2 (25° C.)

R2A AGAR PREPARATION: Suspend 18.1g in 1 liter of distilled water. Bring to the boil to dissolve completely. Sterilize by autoclaving at 121° C. for 15 minutes. Mix well and pour into sterile bacteria enclosure. Before use, the plate needs to be dry and at room temperature (Weight loss of 25-mL agar plates (100×15 mm) dried separately in a laminar-flow hood at room temperature (24 to 26° C.), relative humidity (30 to 33%), and air velocity (0.6 m/s.) until ready to use

HETEROTROPHIC PLATE COUNT: Current invention of the rotating table (25) uses light source (33) underneath the table. Its purpose of wave length controlled light is to encourage the growth of the Heterotrophic micro-organism by inhibit the growth of certain unwanted light sensitive micro-organism, and to provide easy observation by reflecting the growth of bacteria colony using different wave length of light as well as UV sterilization before disposal of sample dish or plate.

After 7 days or desired time of cultivating in room temperature, calculate the CFU value of the sample. Use visual comparison chart or electronic reader or any approved CFU counting method. Here we recommend use OpenCFU software with digital Cam camera (26).

### DESCRIPTION OF THE PRIOR ART

Prior art (see reference 1) are methods of water testing kit, example is the HPC Sampler (EMD Millipore), consisted of a removable dip paddle (11) which contained in a plastic sampler is illustrated in FIG. 1

The dip paddle (11) contains a 0.45μ filter and an absorbent pad (12) with dehydrated agar medium (14) which absorbs 1 mL of the liquid sample, facilitating the recovery of stressed (that is, partially sanitized or nutritionally starved) aerobic bacteria in 7 days under room temperature 68-75° F.

This prior art is designed for simple screening and monitoring purpose.

The gold standard for EPA compliance is use R2A agar and spreading plate method.

Several methods has developed and compared with R2A agar and 9215C spreading plate method. The result showed R2A agar with 9215s′ protocol are still the recommended methods for water testing (see reference 6,7).

Current all methods all focus on lab test and only HPC Sampler (EMD Millipore) developed in office kit that use filter membrane to test water in dental office. As all dental offices already adapt all regulations of State agency to use purified water or sterile water in dental units and also equip autoclave to sterile used media or equipment. Current invention can be easily adapted as a useful tool for dental office water monitoring purpose as well as other purpose has similar goal.

### SUMMARY OF THE INVENTION

The current invention is an utility apparatus and method, including specified light spectrum of wave length used, reasonable rotating stage design to ease of spreading the plate and combining an observation documentation method.

The current invention is also designed to test dental unit waterline or similar environment and for meeting CDC/EPA compliance of drinking water standard. The current invention was developed to monitor water quality by counting the bacteria colony in the office setting with the kit developed.

A complete kit of currently in office test kit includes (as illustrated in FIG. 11):
1. An inter-changeable rotating table (25) to accept single (24) or multiple different size culture enclosure and a main stage (26) to support the rotating table; which combine together and has a variable light source at the bottom. The rotating table with a bar or handle (28) in illustrated in FIG. 3, FIG. 4, FIG. 5 and FIG. 6 is shown and is used to rotate the table with the bacteria enclosure while connected to the main stage (26). This rotating table can be a manually operated mechanism. A mechanically propelling rotating mechanism such as gears can also be added on the side of stage. Light box (27) can include various lights ranging from infrared light to regular light, which can be used for culturing and observing or be used for sterilization with UV light.
2. A prepared Petri dish or plate with culture media (24); sterile
3. A water vessel or sample collecting cup (22); sterile.
4. A L-shape spreader; sterile (21) for spreading method.
5. One −0.5 ml, 1 ml or 3 ml syringes (23) or a 100 uml-1000 uml pipet; sterile
6. An incubator (41)
7. An observing apparatus. (51)

A partial kit is illustrated in FIG. 3 equip with the main stage (26), rotating table (25), variable wave length light source box (27) and other disposable items (21,22,23,24) when independent incubator and observing apparatus are used.

The main component in current invention is to use a rotating table and various wavelength of light as an part in water testing; and R2A agar culture media is used according to 9215s' protocol. Current method makes culture preparation, incubation and counting ability in the same kit prepared.

While Standard Procedure of lab Spread Plate Technique will make multiple dishes and a dilution series from a sample. The approved prior art of HPC Sampler (EMD Millipore) kit tests water sample without dilution and uses the absorbing pad to quickly collect 1 mL water sample for its in office testing kit. As such with the current invention, a total of 0.1 ml (standard size petri dish used) or 1 mL (larger size petri dish used) of the sample water is extracted from vial or sample container (22) and collected into the provided sterile syringe (23) each time. The 0.1 ml or 1 mL sample is then ejected onto the dish or plate with R2A culture media (24) with syringe or pipette after the rotating table (25) has connected to the main stage (26). Thus the sample water is placed onto the R2A agar surface with or without multiple dilution.

After standard method of 0.1 ml with multiple dilution or 1 mL of the sample water is sporadically dripped onto the agar surface, an L-shape spreader (21) is used to spread the sample over the surface of the medium by carefully rotating the table and spread the sample evenly over the surface of agar with the current invention. The invention has multiple interchangeable stages of various sizes that connect to a stage adaptor. The various sized stages are appropriately sized to accommodate single and/or multiple petri dishes. The largest size petri dish that can be accepted by the stage should be no longer than 6 inches in diameter, as described in claim 6.

Incubate the sample at room temperature using our complete kit with incubator (41) or a separate incubator for 7 days. In facts, if R2A agar is used, the best results are obtained at 28° C. with 7 days incubation; if NWRI is used, incubate at 20° C. for 7 days. Here, we define room temperature as 68-75° F.

The current invention designs the rotating table. When the rotating table is used, it will mechanically rotate the culture enclosure by the bar or handle in a flatter surface. The spreader can be then applied to the sample water more easily and more evenly on to the plate than rotating the plate by hand and holding the culture enclosure.

After properly spreading the sample and desired specific spectrum of light activated, the bacteria enclosure can then be cultured in the incubator with room temperature and observe with the light box active when necessary. The preferred media dish or plate is transparent or semi-opaque.

After recommended 7 days of room temperature culture (we define room temperature as 68-75° F.), the observation then can be observed with any magnifier tool. The data of colony count then can be documented.

HETEROTROPHIC PLATE COUNT: Current invention of the rotating table (25) uses LED light source (28) underneath the table. Its main purpose is to illuminate the bacteria colony for easy observation and counting. Different spectrums of wavelength from Infrared to ultraviolet spectrum are also have different impact for micro-organism growth. Variable wavelength lights can be valuable for microbiological research.

After 7 days or desired time of cultivating in room temperature, calculate the CFU value of the sample. Use visual comparison chart or electronic reader or any approved CFU counting method. Here we recommend use OpenCFU software with digital Cam camera (42).

Grid method with comparison chart or a photo then can be captured and saved electronically to a computer flash drive and colony number can then be counted by any advanced software such as OpenCFU.

After colony counting then the culture enclosure can be sterile with autoclave or disposed according to CDC or State guidelines. The UV light diode available under the stage light box can be used to sterilize the micro-organisms in the dish or plate before disposal.

The main component of current invention is a manual or mechanic rotatable table that can be contained by reasonable means, such as a shield or a small laminar flow hood. Under this table or stage, the light source is reflected from the bottom to facilitate colony observation and counting. Regular petri dishes are generally used in this invention; and petri dishes with threaded or sealable cover can be used when there is concern about contamination.

Current invention is also based on thinking using incubator set on room temperature (we define room temperature as 68-75° F.) that can culture micro-organism in a controlled environment. They can be all together made in a unit or dissemble and operated separately.

In addition, the rotating table can host a single petri dish or multiple petri dishes depend of desired size of incubator used. The following illustration in only for demonstration of a single dish assemblymen.

The invention will be illustrated using the attached drawings.

### BRIEF DESCRIPTION OF THE DRAWINGS

FIG. 1 is a perspective illustration of a prior art of HPC Sampler (EMD Millipore) with its water vessel (13) and dip pad (11).

FIG. 2 is a partial cross-sectional prospective view of the prior art shown in FIG. 1, the left side is illustrating its water vessel (12), dip pad (11), absorbent pad with membrane (12) and culture media (14)

FIG. 3 is an illustration of the individual parts of the present invention in claim 1, claim 2 and claim 3, including the rotating table (25), the main stage (26), the light source (27), and the handle for the rotating table (28).

FIG. 4 is a front view or lateral view of the present invention in claim 1, claim 2, and claim 3; including the rotating table (25), the main stage (26), the light source (27), and the handle for the rotating table (28). The main stage (26) its center circle cut (29) is hosting the rotating table body (25) and allow illumination (27) from below the main stage and rotating table.

FIG. 5 is a perspective illustration of the present invention in claim 1, claim 2, claim 3, claim 5, claim 6, Claim 7 and claim 10, with necessary component to make it a kit;

FIG. 6 is a front view or lateral view of the present invention in claim 1, claim 2, claim 3, claim 5, claim 6, claim 7 and claim 10; including two syringes (23) for collecting/ejecting water sample, a container or cup (22) for obtaining water sample, the L-shaped spreader (21), the petri dish (24), the rotating table (25), the main stage (26), the light source (27), and the handle for the rotating table (28).

FIG. 7 is a layered perspective view of the present invention in claim 1, claim 2 , claim 3 and claim 10; illustrates the entire testing kit and its individual components including the circular dish (24), the rotating table (25) with the handle (28), the center circle (29) on main stage (26) to accept rotating table (25), the light source container (27), syringes (23), and a cup (22) for holding the sample water.

FIG. 8 is a layered lateral or side view of the present invention in claim 1, claim 2, claim 3, and claim 10, showing all the components for the testing kit.

FIG. 9 is a prospective view of the present invention in claim 1, claim 2, claim 3, claim 4, claim 5, claim 6, claim 7 and claim 8, with incubator (41) and culture medium (24) shows a more detailed view of the testing apparatus with the incubator box (41).

FIG. 10 is a layered front or lateral view of the present invention in claim 1, claim 2, claim 3, claim 4, claim 5, claim 6, claim 7 and claim 8, with incubator (41) and culture media plate (24), illustrates A side prospective view of the water testing kit with the incubator box (41) at the bottom and the light source (27) above it with the rotating table (25) main stage (26) and the petri dish media plate (24). Although light box is located below the main stage, the light reflection can illuminate the media plate (24) from the side or from the top with mirror or fiber optic channel.

FIG. 11 is a prospective view of the present invention in claim 4; it illustrate a complete kit including incubator (41) and photo capture or observing apparatus (42) and other disposable or serializable items.

FIG. 12 is a different prospective view of the present invention in claim 4; a complete kit including incubator (41) and observing apparatus (42).

FIG. 13 is an oblique prospective view of a normal petri dish with cover. Thread screw design or O-ring seal can be easily add on to it.

FIG. 14 is an oblique prospective illustration of a 3M Petrifilm® design, Petrifilm (53) and its base plate (54). Its center is a circle petri dish like plate and transparent sealable film for observation; Hach's Peel Plate® Heterotrophic Plate Count Media is also has similar design can be accepted by current invention with changing corresponding sizes of hosting rotating stage.

### DESCRIPTION OF THE PREFERRED EMBODIMENTS

To accomplish the objectives set forth above, the FIG. 3, FIG. 4, FIG. 5, FIG. 6, FIG. 7, FIG. 8, FIG. 9, FIG. 10, FIG. 11, FIG. 12 all demonstrate the components of current invention, as in claim 1: illuminator light box (27), in claim 2: main stage (26) and rotating table (25), in claim 3: illuminator (27) and an incubator (41), in claim 4:

As illustrated in FIG. 13 and FIG. 14 are two types of sealable and re-sealable design.

As illustrated in FIG. 13, Normal petri dish (52) and cover (51) which has circle shape, diameter is from one inch to six inches in length is used in current invention as in claim 6. Although use of the thread mechanism or O-ring to tighten the cover and petri dish with corresponding thread can be useful, too.

As in FIG. 14, Peelplate film (53) and its base (54), has re-sealable covering, as in claim 5, similar design can be used to Seal the petri dish as well. However, current invention will also accept such a design with corresponding size rotating stage.

As seen in FIG. 8. A preferred embodiment is a light box from below the supporting stage. Variations such as using reflecting light mirror and redirect the light to illuminate from the side or above should also part of claim of current invention.

Although in FIG. 7, the illustration here describes its components of current invention; however, examples of variation have shown in FIG. 9, which depict a portion of small parts. Incubator is added as a variation.

FIG. 11 illustrated a preferred full set of water test kit. Including current invention, incubator and observing apparatus. Incubator could add a housing to encompass the test sample, which is not illustrated here and it is for a more clear explanation of current concept.

In a usual lab setting, a sample is collected from a dental office, ship to lab with ice pack and labelled. There is possible to delay or contamination during the shipping and it is used for more precise analysis of cultured colony and bacteria strains. The cost is generally high and when there is a need in isolation of certain micro-organism strain. In-office test kit is a valuable and preferred method for in office screening purpose.

In conclusion, according to the description disclosed above, the present invention has the novelty and improvement that a patent should have. And the embodiments given are only for illustrating the present invention; it will be apparent to those skilled in this art that various equivalent modifications or changes without departing from the spirit of this invention, such as increasing or shape changing of the stage or color spectrum of the light, shall also fall within the scope of the appended claims.

### REFERENCES CITED [REFERENCED BY]

1. U.S. Patent Documents

| | | |
|---|---|---|
| U.S. Pat. No. 4,432,763 | February 1984 | Manschot |
| U.S. Pat. No. 4,663,126 | May 1987 | Gould et al. |
| U.S. Pat. No. 5,525,475 | June 1996 | Ladouceur |
| U.S. Pat. No. 6,506,346 | January 2003 | Monro |
| U.S. Pat. No. 0,147,568 | August 2003 | Edwards |
| U.S. Pat. No. 6,753,186B2 | January 2001 | Harold Moskoff |
| WO 2005033696A1 | September 2003 | Carol Mary Turley; |
| | | “Method for water |
| | | testing and devices and |
| | | kit of components for |
| | | use in such a method” |
| WO 1985001579A1 | October 1983 | Barry John Lloyd, Martin |
| | | Snook; “Water test kit |
| | | and component, therefor” |

2. CDC Guidelines:

https://www.cdc.gov/oralhealth/infectioncontrol/questions/dental-unit-water-quality.html

3. EPA Standard for Safe Drinking Water:

https://safewater.zendesk.com/hc/en-us/categories/201454937

4. Dental Unit Waterlines, Water Quality and Boil-water Advisories:

http://www.mae.gov.nl.ca/waterres/quality/drinkingwater/advisories.html

5. OpenCFU, an Open-Source Software to Count Cell Colonies and Other Circular Objects:

https://www.ncbi.nlm.nih.gov/pmc/articles/PMC3574151/6.

6. Evaluation of 3 dental unit waterline contamination testing methods

https://www.ncbi.nlm.nih.gov/pmc/articles/PMC4450747/7.

7. 9215 Heterotrophic Plate Count (2004)

https://www. standardmethods.org/store/productview.cfm?productid=312

8. Comparison of In-Office Dental Unit Waterline Test Kits (2010)

### Maj Barry F. Morris, USAF DC*; Col Kraig S. Vandewalle, USAF DC*;

### Donna M. Hensley, BS†; Joseph A. Bartoloni, DMD, MPH‡

https://www.ncbi.nlm.nih.gov/pubmed/21121503

1. Water Test Kit of current claim, wherein the device utilizes specified wavelength spectrums of infrared (wavelengths from 700 nanometers to 1 millimeters), visible light (wavelengths from about 390 to 700 nanometers) and ultra-violet (wavelengths from 100 nanometers to 400 nanometers) or a combination of any of the former wavelength specified, then sends light through water test apparatus and water quality monitoring apparatus.

2. Waterline Test Kit, of current claim, wherein said a device has a main supporting stage or table; its center circle support a rotating stage or table to place transparent dishes or cultural plate; and allows light source box to transmit light from below.

3. Waterline Test Kit, of current claim; wherein said the use of manual rotating bar or mechanically propelled mechanism, like gears from the side, to rotate the sample rotating stage.

4. Waterline Test Kit, of current claim; is an In-Office test apparatus and method, to culture and monitor the number of bacteria colony from a portable water vessel, wherein said the use of a illuminator under the stage and an incubator.

5. Waterline Test Kit, wherein said the use of the dish or culturing plate is transparent, semi-opaque surface with a white background, whereas the culture enclosure is sealable or re-sealable on top and bottom.

6. Water Test Kit, wherein said uses on culture enclosure which diameter of circle is from one inch to six inches in length.

7. Water Test Kit, wherein said uses reflecting mirror or fiber optic cable to redirect light from above or from the side.

8. Water Test Kit, wherein said uses incubator heating element from above main stage.

9. Water Test Kit, wherein said uses photo capturing device to assist to count and record the growth of bacteria colony.

10. Water Test Kit, wherein uses 0.5 mL to 5 mL syringe or pipet to draw water from a water vessel or sample collecting container.
